(19) United States
(12) Patent Application Publication
(10) Pub. No.: US 2024/0250900 A1
(43) Pub. Date: Jul. 25, 2024

(54) PATH CONTROL APPARATUS, PATH CONTROL METHOD AND PROGRAM

(71) Applicant: Nippon Telegraph and Telephone Corporation, Tokyo (JP)

(72) Inventors: Kei TAKESHITA, Musashino-shi, Tokyo (JP); Yuji SOEJIMA, Musashino-shi, Tokyo (JP)

(21) Appl. No.: 18/564,145

(22) PCT Filed: Jun. 10, 2021
(86) PCT No.: PCT/JP2021/022158

§ 371 Date: Nov. 27, 2023

(51) Int. Cl. H04L 45/302; H04L 45/00; H04L 45/28; H04L 47/125

(52) U.S. Cl. CPC H04L 45/308; H04L 45/28; H04L 45/34; H04L 47/125

(57) ABSTRACT

A data generation device (path control device) 1 is provided with a management unit 14 that estimates and calculates a communication quality of each path in a case where a path passing through a communication device assumed to be failed is moved to a port through which a path passing through a communication device of a redundant system passes by using a communication quality estimation model that learns a relationship between a load in units of ports and a communication quality of a path caused by passing through a port, and a control unit 13 that moves the path passing through the communication device assumed to be failed to the port of the communication device of the redundant system on the basis of the estimated and calculated communication quality of each path.

### TECHNICAL FIELD

The present invention relates to a path control device, a path control method, and a path control program.

### BACKGROUND ART

When providing a communication network service, it is important to grasp and maintain a quality of service (QOS) requested by a user. The QoS is a communication quality when the user performs communication in a state (load state, topology and the like) of the communication network at a certain point of time. For example, the QoS is a delay time, a response speed, a packet loss rate, and a data download speed. By grasping a relationship between the state of the communication network and a state of the Qos, it is possible to control the Qos by analyzing a communication status and selecting a countermeasure.

In order to grasp a causal relationship between the state of the communication network and the state of the Qos, it is important to grasp a state of a high-load time in which the Qos is likely to fluctuate. However, since the communication network is equipped with surplus resources such that a failure or various risks do not occur during operation, it is difficult to create the state of the high-load time, and it is difficult to grasp the causal relationship. Therefore, Patent Literature 1 discloses a method of simulatively creating the state of the high-load time by duplicating traffic to apply.

### CITATION LIST

### Patent Literature

Patent Literature 1: JP 2020-137101 A

### SUMMARY OF INVENTION

### Technical Problem

However, in Patent Literature 1, since a simulated packet is applied, and the traffic to be applied is different from actual traffic, randomness of the traffic is insufficient and the state of the high-load time cannot be appropriately created. Furthermore, since the load is fixedly applied, there is a possibility that the load is excessively applied.

The present invention is achieved in view of the above-described circumstances, and an object thereof is to provide a technology capable of appropriately creating the state of the high-load time in the communication network.

### Solution to Problem

A path control device according to an aspect of the present invention is provided with a management unit that estimates and calculates a communication quality of each path in a case where a path passing through a communication device assumed to be failed is moved to a port through which a path passing through a communication device of a redundant system passes by using a communication quality estimation model that learns a relationship between a load in units of ports and a communication quality of a path caused by passing through a port, and a control unit that moves the path passing through the communication device assumed to be failed to the port of the communication device of the redundant system on the basis of the estimated and calculated communication quality of each path.

A path control method according to an aspect of the present invention performed in a path control device performs a step of estimating and calculating a communication quality of each path in a case where a path passing through a communication device assumed to be failed is moved to a port through which a path passing through a communication device of a redundant system passes by using a communication quality estimation model that learns a relationship between a load in units of ports and a communication quality of a path caused by passing through a port, and a step of moving the path passing through the communication device assumed to be failed to the port of the communication device of the redundant system on the basis of the estimated and calculated communication quality of each path.

A path control program according to an aspect of the present invention allows a computer to serve as the above-described path control device.

### Advantageous Effects of Invention

According to the present invention, it is possible to provide a technology capable of appropriately creating a state of a high-load time in a communication network.

### BRIEF DESCRIPTION OF DRAWINGS

FIG. 1 is a diagram illustrating an overall configuration of a system.

FIG. 2 is a diagram illustrating a processing flow of a data generation device.

FIG. 3 is a diagram illustrating an example of path control.

FIG. 4 is a diagram illustrating an image of a QoS estimation model.

FIG. 5 is a diagram illustrating an example of path control according to a first control method.

FIG. 6 is a diagram illustrating an example of path control according to a second control method.

FIG. 7 is a diagram illustrating an example of path control according to a third control method.

FIG. 8 is a diagram illustrating a hardware configuration of the data generation device.

### DESCRIPTION OF EMBODIMENTS

Hereinafter, an embodiment of the present invention will be described with reference to the drawings. In the drawings, the same parts are denoted by the same reference signs, and the description thereof is omitted.

### SUMMARY OF INVENTION

As described above, in order to grasp a causal relationship between a state of a communication network and a state of a QoS, it is important to grasp a state of a high-load time in which the Qos is likely to fluctuate.

Therefore, in the present invention, in a software defined network (SDN) in which path control such as segment routing (SR) may be performed, the state of the high-load time is created by gathering traffic to a specific port, and a load characteristic and a QoS characteristic for each port are sequentially acquired in this state. Furthermore, when the traffic is gathered to a specific port, the path control is performed so as to concentrate the traffic within a range not exceeding a service level agreement (SLA) of a user by using a QOS estimation model that learns a relationship between a load of the communication network and the QoS.

In this manner, in the present invention, since the load is not applied to an entire communication network, it is possible to grasp a behavior when a specific communication device or port becomes a bottleneck. That is, it is possible to appropriately create the state of the high-load time in the communication network, and it is possible to grasp the relationship between the state of the communication network and the state of the QoS.

### [Overall Configuration of System]

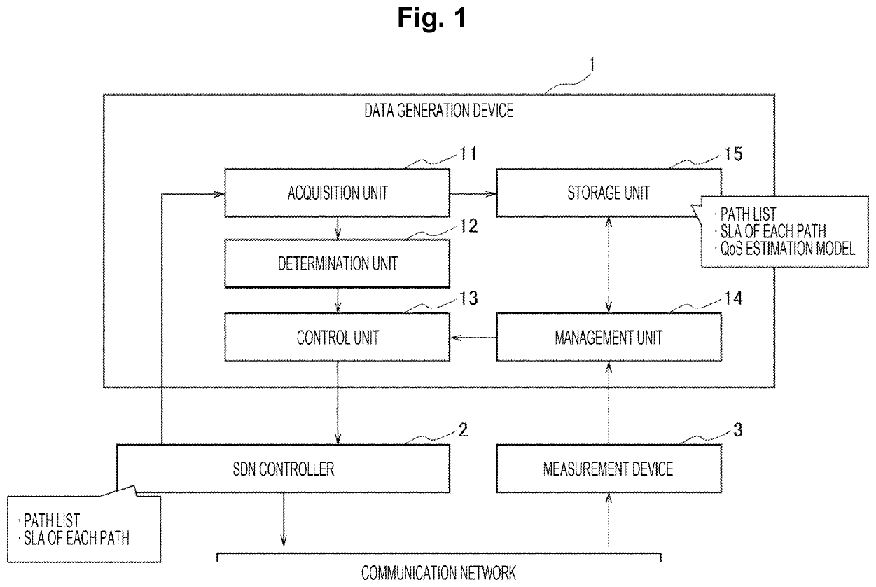

FIG. 1 is a diagram illustrating an overall configuration of a system. The system according to the present embodiment includes a data generation device 1, an SDN controller 2, and a measurement device 3.

The SDN controller 2 stores data regarding a path list of each path passing through a communication network, an SLA of each path and the like, performs centralized control of a communication device group forming the communication network, and dynamically changes a configuration and setting of the communication network. The SDN controller 2 is an existing device.

The measurement device 3 includes an operating system (OS), an application program and the like of a user terminal, and measures a load (for example, a traffic amount, a CPU usage rate and the like) applied to the path passing through the communication network, and a QoS (for example, a delay time, a response speed, a packet loss rate, a data download speed and the like). The measurement device 3 is an existing device.

The data generation device 1 is a path control device that controls the path in the communication network by using a QoS estimation model, and is also a data generation device that generates training data of the Qos estimation model. As illustrated in FIG. 1, the data generation device 1 that is also the path control device includes an acquisition unit 11, a determination unit 12, a control unit 13, a management unit 14, and a storage unit 15. Two or more functional units may be integrated into one, or one functional unit may be divided into two or more parts.

The acquisition unit 11 has a function of acquiring the data regarding the path list of each path passing through the communication network, the SLA of each path and the like from the SDN controller 2, and storing the acquired data in the storage unit 15.

The determination unit 12 has a function of determining a port to be analyzed with reference to the path list, and determining a path passing through the determined port to be analyzed as a path to be analyzed.

The management unit 14 has a function of estimating and calculating the communication quality (QoS) of each path in a case where a path not to be analyzed is moved to the port to be analyzed through which the path to be analyzed passes by using the QOS estimation model that learns the relationship between the load of the communication network and the communication quality (QoS) of each path.

The control unit 13 has a function of moving the path not to be analyzed to the port to be analyzed within a range in which the estimated and calculated communication quality of each path does not exceed an upper limit value of the communication quality of each path (a guaranteed value of the communication quality of the path of the user defined in the SLA, hereinafter, an SLA value) on the basis of the communication quality (QoS) of each path estimated and calculated by the management unit 14.

The management unit 14 has a function of receiving measurement values of the load of the communication network and the communication quality of each path from the measurement device 3, inputting the received measurement values to the QOS estimation model as the training data of the QoS estimation model, and allowing the QOS estimation model to learn by using the input training data.

The storage unit 15 has a function of storing the path list of each path passing through the communication network, the SLA of each path, the Qos estimation model and the like.

### [Operation of Data Generation Device]

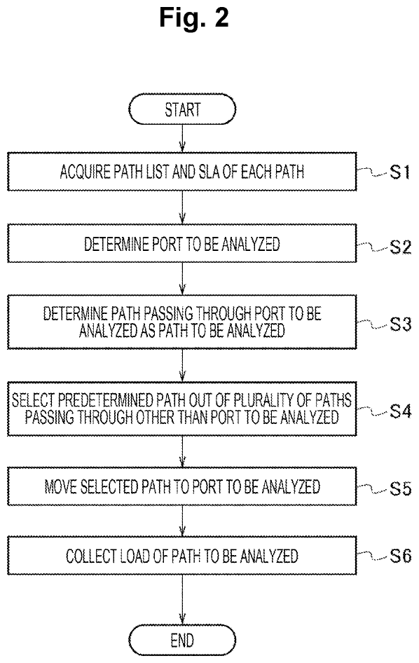

FIG. 2 is a diagram illustrating a processing flow of the data generation device 1.

This is a method of generating a high-load state by concentrating the traffic on a specific communication device within a range in which SLA violation does not occur, and acquiring data for analyzing a correlation between the load of the communication device and the Qos, on the basis of a path control technology such as SR and a traffic model of the device load and the QoS.

First, the acquisition unit 11 acquires topology information of the communication network such as the path list passing through the communication network and the SLA of each path from the SDN controller 2 (step S1).

Next, the determination unit 12 determines a communication device and a port to be analyzed out of a plurality of communication devices forming the communication network with reference to the acquired topology information (step S2), and determines the path passing through the determined port to be analyzed as the path to be analyzed (step S3).

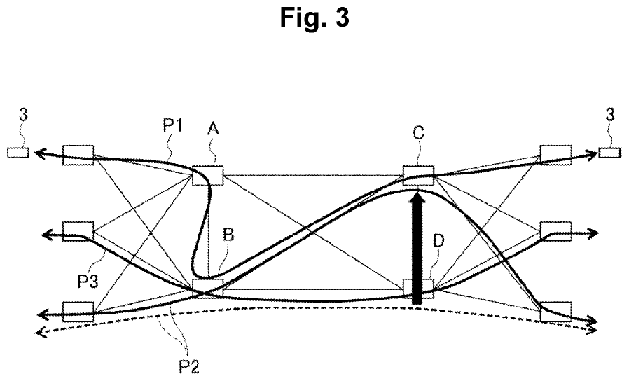

As illustrated in FIG. 3, in a case where the communication network includes four communication devices A to D, the determination unit 12 determines, for example, the communication device C as the communication device to be analyzed, and determines a predetermined port out of a plurality of ports included in the communication device C as the port to be analyzed. Furthermore, the determination unit 12 determines a path P1 passing through the determined port to be analyzed as the path to be analyzed.

Next, the control unit 13 selects a predetermined path out of a plurality of paths passing through a port other than the port to be analyzed (step S4), and transmits a movement command to move the selected predetermined path to the port to be analyzed to the SDN controller 2 (step S5). The SDN controller 2 that receives the movement command of the path changes the setting of the communication device group so that the selected path is moved to the port to be analyzed.

In a case of the communication network illustrated in FIG. 3, for example, the control unit 13 selects a path P2 out of two paths P2 and P3 that do not pass through the port to be analyzed of the communication device C, and allows the selected path P2 to pass through the port to be analyzed of the communication device C.

At that time, the control unit 13 selects such a path that the communication quality of the path to be analyzed does not reach the SLA value of the path to be analyzed (that is, the SLA value is not exceeded) even if the selected predetermined path is moved to the port to be analyzed and a load of the port to be analyzed increases.

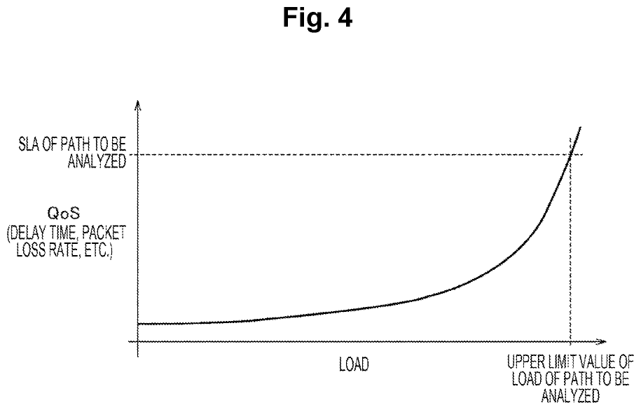

Specifically, for example, the management unit 14 estimates and calculates the communication quality (QOS) of the path P1 to be analyzed in a case where the above-described selected path P2 is moved to the port to be analyzed through which the path P1 to be analyzed passes by using the QoS estimation model illustrated in FIG. 4. Then, the control unit 13 selects such a path that the estimated and calculated communication quality of the path P1 to be analyzed is equal to or lower than the SLA value of the path P1 to be analyzed. It goes without saying that the control unit 13 also sets the communication quality of the path P2 to be equal to or lower than the SLA value of the path P2 for the selected path P2.

That is, at step S4, the control unit 13 applies the traffic of the path not to be analyzed to the port to be analyzed while constantly monitoring the load of the port to be analyzed by the measurement device 3, and at that time, this checks the SLA of the user and selects a path with a margin in the SLA value.

Finally, the management unit 14 collects the measurement values of the load applied to the path to be analyzed and the communication quality from the measurement device 3, inputs the collected measurement values as the training data of the QOS estimation model, and allows the QOS estimation model to learn by using the input training data (step S6).

Note that, the data generation device 1 may apply the high load to another port of the communication device C and each port of the communication devices A, B, and D in a similar manner.

In this manner, in the present embodiment, the traffic of the path is gathered to a specific port so that the high load may be applied, and the load characteristic for each port is sequentially acquired. Furthermore, when the traffic is gathered to a specific port, the path control is performed so as to concentrate the traffic within the range not exceeding the SLA of the user on the basis of the QOS estimation model that learns the relationship between the load of the communication network and the communication quality.

In the present embodiment, since the load is not applied to an entire communication network, it is possible to grasp a behavior when a specific communication device or port becomes a bottleneck. That is, it is possible to appropriately create the state of the high-load time in the communication network, and it is possible to grasp the relationship between the state of the communication network and the state of the communication quality (QOS).

### [Path Control Method]

An example of a path control method is described.

### [First Control Method]

In a first control method, a safe path gathering method assuming a failure of the communication device is described. This is a method of collecting data for analyzing the QOS at the time of failure within the range in which the SLA violation does not occur on the assumption of the failure of the communication device.

As described above, the data generation device 1 may acquire the SLA for each path from the SDN controller 2, and may acquire propagation delay and processing delay from the measurement device 3.

In the first control method, the QoS estimation model is a delay estimation model (communication quality estimation model) in units of ports that learns a relationship between a load in units of ports and a delay time (communication quality) of a path caused by passing through a port. For example, the QOS estimation model to which a traffic amount (pps/bps) in units of ports at a certain point of time, a total traffic amount within a predetermined time, a CPU usage rate and the like are input outputs the delay time caused by passing through the port.

The management unit 14 has a function of estimating and calculating the delay time of each path in a case where a path passing through a communication device assumed to be failed is moved to a port through which a path passing through a communication device of a redundant system passes by using the delay estimation model described above.

The control unit 13 has a function of moving the path passing through the communication device assumed to be failed to the port of the communication device of the redundant system within a range in which the estimated and calculated delay time of each path does not exceed an upper limit value of the delay time of each path (a guaranteed value of the delay time of the path of the user defined in the SLA, hereinafter, an SLA value) on the basis of the estimated and calculated delay time of each path.

The management unit 14 has a function of receiving measurement values of the load of the port of the communication device of the redundant system and each path delay time caused by passing through the port from the measurement device 3 after the path moves, inputting the received measurement values to the delay estimation model as training data of the delay estimation model, and allowing the delay estimation model to learn by using the input training data.

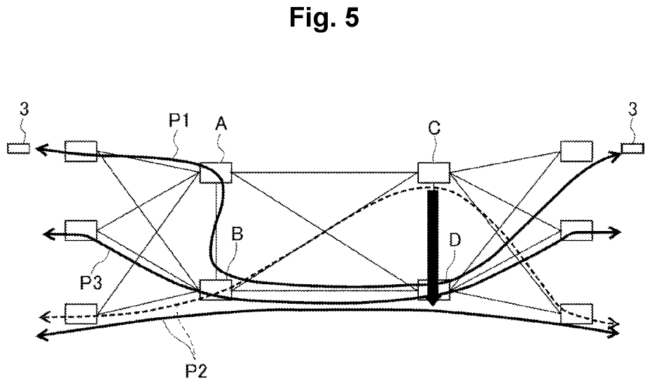

First, it is assumed that any of a plurality of communication devices forming the communication network fails. The control unit 13 selects a path passing through the communication device assumed to be failed, and moves the selected path to a predetermined port of the communication device of the redundant system. For example, in a case of the communication network illustrated in FIG. 5, assuming that the communication device C fails, the control unit 13 moves the path P2 passing through the communication device C to a predetermined port of the communication device D, which is the communication device of the redundant system.

At that time, the control unit 13 selects such a path that the delay time of the path in the predetermined port does not reach the SLA value of the path (that is, the SLA value is not exceeded) even if the selected path is moved to the predetermined port of the communication device of the redundant system and the load of the predetermined port increases. That is, the control unit 13 applies, while constantly monitoring the load of the port of the communication device of the redundant system by the measurement device 3, the traffic of the selected path to the port, and at that time, this checks the SLA of the user, selects a path with a margin in the SLA value, and applies the path while adjusting.

For example, a processing time is divided into regular time sections, and in a first time section, a predetermined number of paths are moved within a range in which the delay time does not violate the SLA value by using an initial delay estimation model. Note that, the initial number of moved paths is within a constant rate or a constant number out of a plurality of paths passing through the communication device assumed to be failed. Furthermore, the delay load of other communication devices caused by moving the path is also taken into consideration. Thereafter, an actual delay time is measured, and the measured delay time is input to the delay estimation model to update the delay estimation model. As for subsequent time sections also, by repeatedly executing similar processing by using the updated delay estimation model, the paths are gradually moved without causing drastic quality degradation.

By reducing the number of moved paths per one time and the like from the time section in which the delay time is assumed to be long, fluctuation in quality is further reduced. By moving the path on the basis of an equation such as TCP cubic, in a case where the initial delay estimation model is wrong, the delay time is further extended to perform a search.

### [Second Control Method]

A second control method is a method of collecting the data by amplifying the traffic by allowing the traffic of the path to pass a plurality of times.

As described above, since the communication network is equipped with surplus resources at the time of operation, it is often difficult to reliably create the high-load state even if the traffics of all the paths are gathered to one communication device or one port. Therefore, in a case where there is a large surplus in the delay time, the control unit 13 allows a path to be moved to pass through the port of the same communication device a plurality of times within a range not exceeding the SLA value to increase the load, allows the delay estimation model to learn, and observes a behavior of the communication device.

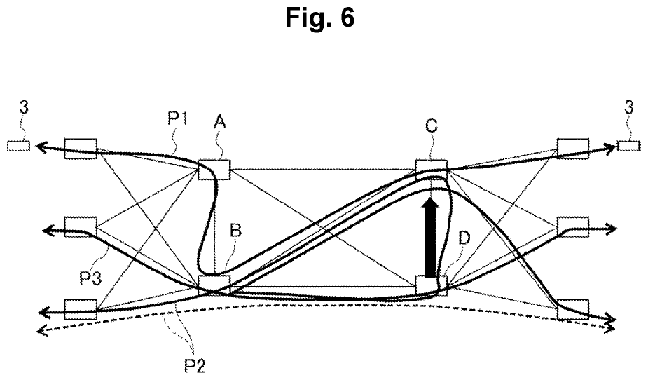

That is, the control unit 13 has a function of inputting an optional path passing through a predetermined port of a communication device (including the communication device of the redundant system described in the first control method) in the communication network to this port a plurality of times. For example, in a case of the communication network illustrated in FIG. 6, the control unit 13 allows a path P2 to be moved passing through the communication devices B and D to pass through the communication devices B, C, D, B, and C in this order.

For example, the control unit 13 selects a plurality of paths to be moved allowed to pass through a predetermined port of the communication device a plurality of times, and determines the number of loops. The number of loops may be one. Next, the control unit 13 sequentially selects the paths with large traffic from the paths with a small change in the number of hops due to a path route change out of a plurality of paths to be moved. Next, the control unit 13 calculates a delay amount from a length of the route after the change for the selected path to be moved, estimates a delay increase amount of the target port due to the change in the traffic amount from the delay estimation model, and changes the path to be moved only in a case where the delay time of the path to be moved does not exceed the SLA value. Thereafter, the control unit 13 executes learning processing of the delay estimation model for the above-described predetermined port.

### [Third Control Method]

In a third control method, a method of learning an increase in load of a communication device other than the communication device to be analyzed is described. This is a method of collecting the data by reproducing a delay increasing scene of other than the communication device to be analyzed when analyzing the analysis target.

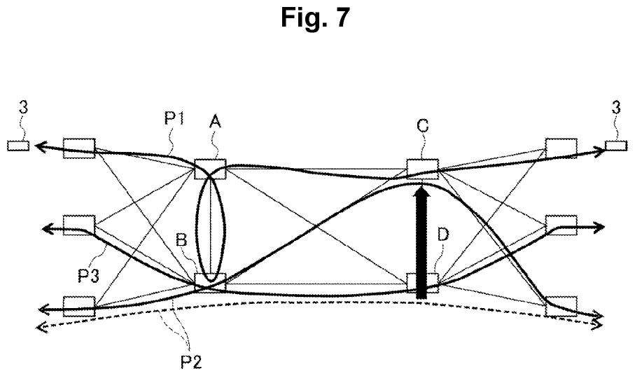

An End-to-End delay also fluctuates in places other than the communication device to be analyzed. Therefore, the control unit 13 has a function of controlling a route of an optional path such that a load by the optional path passing through a predetermined port of the communication device (including the communication device of the redundant system described in the first control method) in the communication network increases in the communication device other than this communication device. For example, as illustrated in FIG. 7, the control unit 13 allows the path P1 to be analyzed passing through the communication device C to be analyzed to pass through the communication devices A, B, A, and C in this order. As a result, it is possible to increase the load of the communication device A other than the communication device C to be analyzed, and it is possible to reproduce a state in which the delay increases even in a case where the load of the communication device C to be analyzed is low.

### [Effects]

According to the present embodiment, a data generation device (path control device) 1 is provided with a management unit 14 that estimates and calculates a communication quality of each path in a case where a path passing through a communication device assumed to be failed is moved to a port through which a path passing through a communication device of a redundant system passes by using a communication quality estimation model that learns a relationship between a load in units of ports and a communication quality of a path caused by passing through a port, and a control unit 13 that moves the path passing through the communication device assumed to be failed to the port of the communication device of the redundant system on the basis of the estimated and calculated communication quality of each path, so that it is possible to present a technology capable of appropriately creating a state of a high-load time in a communication network.

### [Others]

The present invention is not limited to the above-described embodiment. The present invention may be modified in various manners within the gist of the present invention.

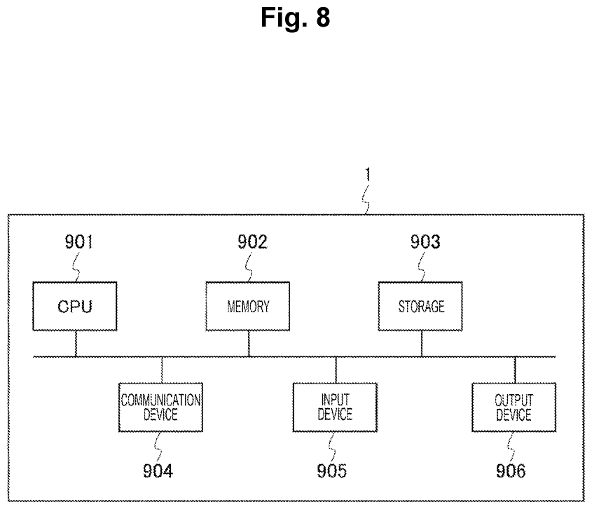

For example, as illustrated in FIG. 8, the data generation device 1 of the present embodiment described above may be implemented by using a general-purpose computer system including a CPU 901, a memory 902, a storage 903, a communication device 904, an input device 905, and an output device 906. The memory 902 and the storage 903 are storage devices. In the computer system, each function of the data generation device 1 is implemented by the CPU 901 executing a predetermined program loaded on the memory 902.

The data generation device 1 may be implemented by a single computer. The data generation device 1 may be implemented by a plurality of computers. The data generation device 1 may be a virtual machine mounted on the computer. A program for the data generation device 1 may be stored in a computer-readable recording medium such as a HDD, an SSD, a USB memory, a CD, or a DVD. The program for the data generation device 1 may also be distributed via a communication network.

### REFERENCE SIGNS LIST

1 Data generation device (path control device)
11 Acquisition unit
12 Determination unit
13 Control unit
14 Management unit
15 Storage unit
2 SDN controller
3 Measurement device
901 CPU
902 Memory
903 Storage
904 Communication device
905 Input device
906 Output device

1. A path control device comprising one or more processors configured to execute instructions that cause the path control device to perform operations comprising:
estimating and calculating a communication quality of each path in a case where a path passing through a communication device assumed to be failed is moved to a port through which a path passing through a communication device of a redundant system passes by using a communication quality estimation model that learns a relationship between a load in units of ports and a communication quality of a path caused by passing through a port; and
moving the path passing through the communication device assumed to be failed to the port of the communication device of the redundant system on the basis of the estimated and calculated communication quality of each path.

2. The path control device according to claim 1, wherein the operations further comprise receiving measurement values of a load of the port of the communication device of the redundant system and a communication quality of each path caused by passing through the port from a measurement device after the path moves, and making the measurement values training data of the communication quality estimation model.

3. The path control device according to claim 1, wherein the one or more processors are configured to move the path passing through the communication device assumed to be failed to the port of the communication device of the redundant system within a range in which the estimated and calculated communication quality of each path does not exceed an upper limit value of the communication quality of each path.

4. The path control device according to claim 1, wherein the communication quality estimation model is a delay estimation model that estimates and calculates a delay amount of a packet of a path from a traffic amount of the path.

5. The path control device according to claim 1, wherein the one or more processors are configured to input an optional path passing through the port of the communication device of the redundant system to the port a plurality of times.

6. The path control device according to claim 1, wherein the one or more processors are configured to control a route of the optional path such that a load by the optional path passing through the port of the communication device of the redundant system increases in a communication device other than the communication device of the redundant system.

7. A path control method performed in a path control device, the path control method comprising:
estimating and calculating a communication quality of each path in a case where a path passing through a communication device assumed to be failed is moved to a port through which a path passing through a communication device of a redundant system passes by using a communication quality estimation model that learns a relationship between a load in units of ports and a communication quality of a path caused by passing through a port; and
moving the path passing through the communication device assumed to be failed to the port of the communication device of the redundant system on the basis of the estimated and calculated communication quality of each path.

8. (canceled)

9. A non-transitory computer-readable medium storing program instructions that, when executed, cause one or more processors to perform operations comprising:
estimating and calculating a communication quality of each path in a case where a path passing through a communication device assumed to be failed is moved to a port through which a path passing through a communication device of a redundant system passes by using a communication quality estimation model that learns a relationship between a load in units of ports and a communication quality of a path caused by passing through a port; and
moving the path passing through the communication device assumed to be failed to the port of the communication device of the redundant system on the basis of the estimated and calculated communication quality of each path.
